(19) United States
(12) Patent Application Publication
(10) Pub. No.: US 2022/0211175 A1
(43) Pub. Date: Jul. 7, 2022

(54) CABINET AND METHOD OF MANUFACTURING

(71) Applicant: Terence Huggins, Kamloops (CA)

(72) Inventor: Terence Huggins, Kamloops (CA)

(21) Appl. No.: 17/144,122

(22) Filed: Jan. 7, 2021

(51) Int. Cl. A47B 47/00; F16B 5/00

(52) U.S. Cl. CPC A47B 47/0075; F16B 5/0012

(57) ABSTRACT

A cabinet comprised of side panel members, a top panel member and a bottom panel member wherein the cabinet is configured to be releasably secured so as to be shipped in a disassembled state. The cabinet further includes a back panel member that will operably couple with all other panel members of the cabinet. The back panel member includes a dadoed rabbet edge along both of the lateral edges and both of the longitudinal edges. The formation of the edges of the back panel member facilitate a securing to the two side panel members, the tope panel member and the bottom panel member so as to provide greater structural integrity of the cabinet and improved load bearing. The panel members of the cabinet include grooves formed on inner surfaces thereof and further have locking mechanisms and locking receptacles that are configured to provide assembly of the cabinet.

### FIELD OF THE INVENTION

The present invention relates generally to cabinets, more specifically but not by way of limitation, a cabinet and a method of manufacturing wherein the cabinet is configured to be transported in a disassembled state and then assembled upon arrival to the destination wherein the present invention provides construction elements to the cabinet that provide improved durability and structural stability.

### BACKGROUND

As is known in the art, cabinets of various types are installed in both residential and commercial building. Cabinets are deployed for numerous applications such as but not limited to kitchens and bathrooms for residential structures and various types of storage in commercial applications. Commonly there are two types of techniques for manufacturing for installation of cabinets in residential and commercial applications. One technique is to provide custom on-site building of cabinets from suitable material such as but not limited to wood. By way of example but not limitation, many high end residential homes will have custom cabinets built onsite from exotic woods or other materials. This technique is quite time consuming and very expensive due to the materials and labor cost. Alternatively, another technique is to have pre-manufactured cabinets that are available in common sizes. These types of cabinets are more cost effective and can be shipped assembled or shipped in a disassembled state and subsequently assembled upon arrival to the final destination.

Cabinets that are manufactured to be shipped disassembled are most commonly manufactured by automated machines commonly known as CNC machines. These machines will execute techniques on the cabinet pieces such as but not limited to routing wherein the cabinet pieces are machined with various elements that will facilitate assembly of the cabinet. These elements can be features such as but not limited to grooves and rabbet formations. Existing technology does not provide a cabinet constructed to be assembled at destination that has the structural integrity or load bearing capability equivalent to a cabinet built onsite with different techniques.

Accordingly, there is a need for cabinet that is manufactured to be shipped in a disassembled state wherein the pieces of the cabinet of the present invention include elements that provide improved durability, structural integrity, and load bearing capabilities once assembled.

### SUMMARY OF THE INVENTION

It is the object of the present invention to provide a cabinet that is manufactured from a plurality of pieces so as to be shipped in a disassembled state wherein the cabinet of the present invention is comprised of a plurality of pieces.

Another object of the present invention is to provide a cabinet comprised of a plurality of pieces that have elements formed thereon to facilitate assembly of the cabinet wherein the cabinet of the present invention includes side members.

A further object of the present invention is to provide a cabinet that is manufactured from a plurality of pieces so as to be shipped in a disassembled state wherein the cabinet of the present invention includes a top end member and a bottom end member.

Still another object of the present invention is to provide a cabinet comprised of a plurality of pieces that have elements formed thereon to facilitate assembly of the cabinet wherein the members of the body of the cabinet of the present invention include barbed channel key slot cavities operable to receive barbed channel lock keys.

An additional object of the present invention is to provide a cabinet that is manufactured from a plurality of pieces so as to be shipped in a disassembled state wherein the cabinet of the present invention includes a back panel member that includes edge and end rabbet dado formations.

Yet a further object of the present invention is to provide a cabinet comprised of a plurality of pieces that have elements formed thereon to facilitate assembly of the cabinet wherein the back panel member is constructed to provide improved load bearing and structural integrity.

Another object of the present invention is to a provide a cabinet that is manufactured from a plurality of pieces so as to be shipped in a disassembled state wherein the elements formed in the back panel member improve the ease of assembling the cabinet.

Still a further object of the present invention is to provide a cabinet comprised of a plurality of pieces that have elements formed thereon to facilitate assembly of the cabinet wherein the cabinet is constructed with elements to facilitate initial assembly as well as subsequent disassembly and re-assembly.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is detailed view of a portion of the assembled cabinet of the present invention; and

FIG. 2 is a detailed view of ends of panel members; and

FIG. 3 is a detailed view of side panels of the present invention; and

FIG. 4 is a partially assembled view of an embodiment of the present invention; and

FIG. 5 is a detailed view of three panels operably coupled; and

FIG. 6 is a detailed view of the back panel member of the present invention; and

FIG. 7 is a rear view of an assembled cabinet of the present invention; and

FIG. 8 is a detailed view of the inner surface of a side panel of the present invention; and

FIG. 9 is a detailed view of an alternative embodiment of the rear panel of the present invention.

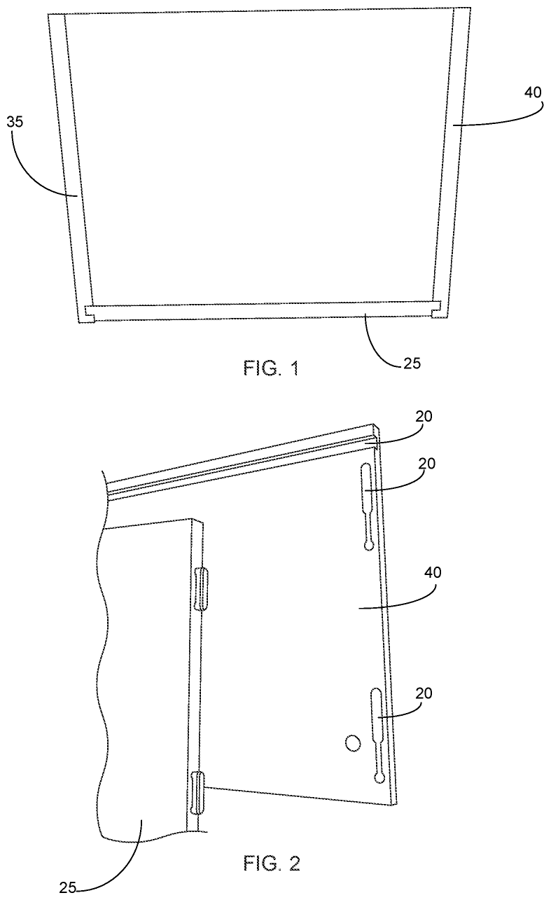

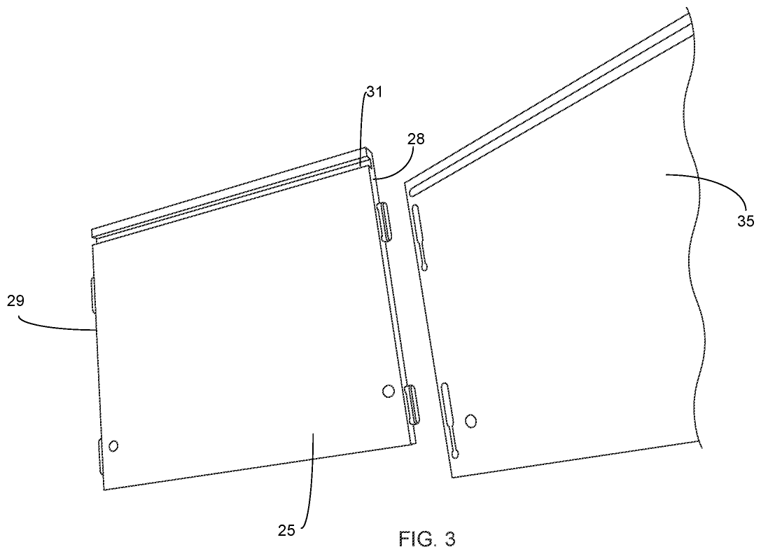

### DETAILED DESCRIPTION

Referring now to the drawings submitted herewith, wherein various elements depicted therein are not necessarily drawn to scale and wherein through the views and figures like elements are referenced with identical reference numerals, there is illustrated a cabinet 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the cabinet 100 includes a body 10 wherein the body 10 is comprised of a plurality of panel members 15. The panel members 15 include assembly elements 20 that are operable to facilitate the assembly, disassembly and reassembly of the body 10 of the cabinet 100. The panel members 15 are illustrated herein of a particular size and shape for illustration purposes only. It should be understood within the scope of the present invention that the panel members 15 could be formed in alternate sizes and shapes in order to create a body 10 of a desired assembled size and shape. It should be further understood within the scope of the present invention that the body 10 could be assembled from various quantities of panel members 15. Furthermore, it should be understood within the scope of the present invention that the panel members 15 could be manufactured from various materials such as but not limited to wood. As is further discussed herein, the panel members 15 will have dado grooves formed thereon. It should be understood within the scope of the present invention that the some of the dado grooves can be a stopped groove wherein the stopped groove does not extend the length of the panel member 15 while others can be a through groove extending the length of the panel member 15.

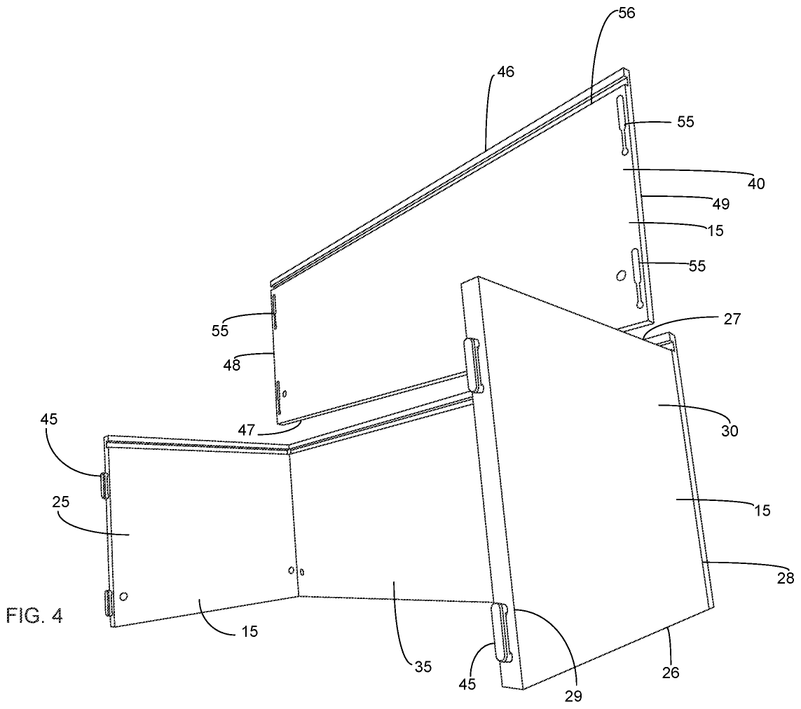

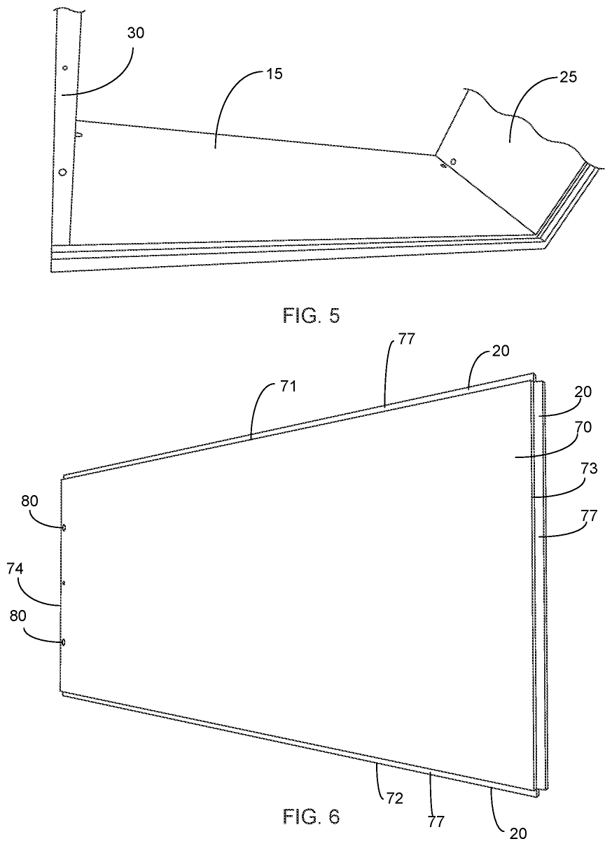

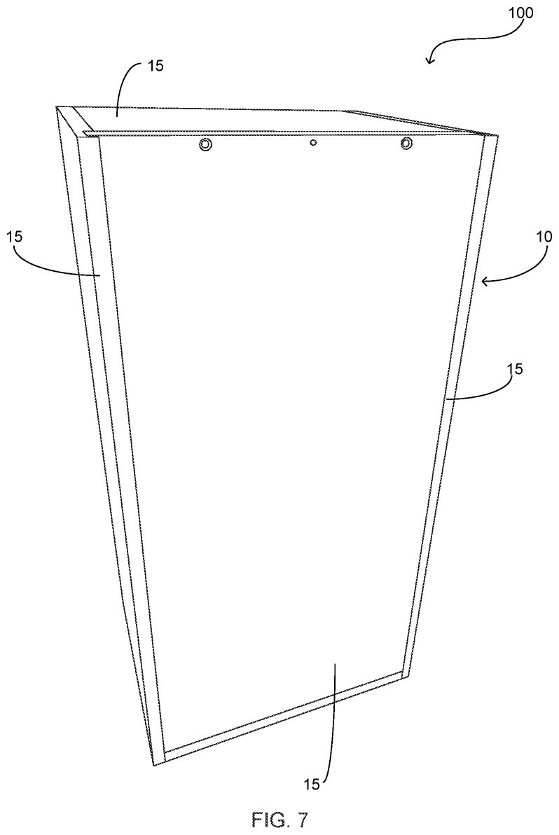

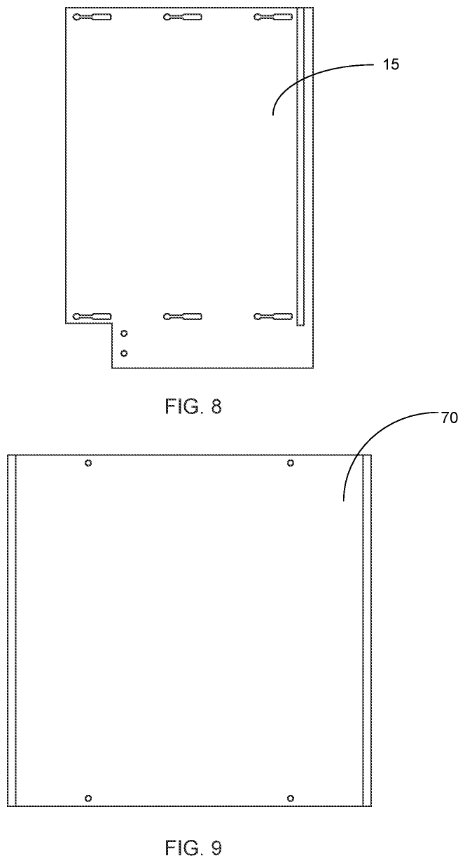

Referring in particular to FIG. 4, an exemplary portion of a cabinet 100 is illustrated therein. A top panel member 25 and bottom panel member 30 are configured to be operably coupled to a first side panel member 35 and a second side panel member 40. The top panel member 25 is square in shape having a front edge 26, a rear edge 27 and opposing lateral edges 28,29. The top panel member 25 includes locking mechanisms 45 formed in the opposing lateral edges 28,29 generally located proximate the front edge 26 and rear edge 27. The locking mechanisms 45 are configured to mateably engage with the locking receptacles 55 that are formed in the inner surface of the first side panel 35 and second side panel 40. While various mechanisms can be utilized for the locking mechanisms 45, in a preferred embodiment of the present invention the locking mechanisms 45 are lock dowels wherein the lock dowels are configured to mateably engage and releasably secure with the locking receptacles 55. The top panel member 25 includes a groove 31 formed on the inner surface wherein the groove extends between the opposing lateral edges 28,29. The groove 31 is formed using a dado technique and is configured to receive an edge of the back panel member 70 as is further discussed herein. It should be understood within the scope of the present invention that the groove 31 could be formed in alternate widths so as to accommodate a back panel member 70 having different thicknesses. The bottom panel member 30 is constructed identically as the top panel member 25 and is opposedly located on the cabinet 100 in its assembled state. The bottom panel member 30 includes locking mechanisms 45 that are configured to operably couple to the locking receptacles 55.

The first side panel 35 and second side panel 40 are operably coupled to the top panel member 25 and bottom panel member 30 on opposing sides thereof. The first side panel 35 and second side panel 40 are identically constructed and as such the ensuing discussion of the second side panel 40 should be understood to be applicable to the first side panel 35. The second side panel 40 includes a first longitudinal edge 46, a second longitudinal edge 47, a first lateral edge 48 and a second lateral edge 49. The second side panel 40 is rectangular in the embodiment illustrated herein but it should be understood that the second side panel 40 could be provided in alternate shapes so as to provide a cabinet 100 of a different shape. The second side panel 40 includes groove 56 formed on the inner surface thereof. The groove 56 is adjacent the first longitudinal edge 46. Groove 56 is formed intermediate the first lateral edge 48 and second lateral edge 49 extending the length of the second side panel 40.

Referring now in particular to FIG. 6, the back panel member 70 is illustrated therein. The back panel member 70 includes opposing longitudinal edges 71,72 and opposing lateral edges 73,74. The back panel member 70 is rectangular in shape in the embodiment illustrated herein but it should be understood within the scope of the present invention that the back panel member 70 could be provided in alternate shapes. The opposing longitudinal edges 71,72 and opposing lateral edges 73,74 have formed thereon edge rabbet formations 77. The edge rabbet formations 77 are formed utilizing a dado technique and fully extend between the opposing longitudinal edges 71,72 and the opposing lateral edges 73,74. The back panel member 70 further includes apertures 80 that are operable to receive fasteners therethrough that will mechanically couple to the top panel member 25. The combination of the dadoed edge rabbet formations 77 and fasteners provides a mateable coupling of the back panel member that offers improved durability, structural integrity and load bearing compared to alternate techniques. Furthermore, the structure of the back panel member 70 facilitates improved assembly time of the cabinet 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

1. A cabinet configured to be shipped in a disassembled state and assembled at an origin site wherein the cabinet comprises:
a body, said body being manufactured from a rigid material, said body including a plurality of panel members, said panel members having assembly elements integrally formed thereon, said plurality of panel members configured to be removably coupled utilizing said assembly elements, said assembly elements formed from a combination of lock dowels and slidable locking receptacles;
at least two side panel members, said at least two side panel members having a first longitudinal edge and a second longitudinal edge, said at least two side panel members having a top end and a bottom end, said at least two side panel members having at least one groove, said at least one groove being formed on an inner surface of said at least one side panels, said at least one groove being formed adjacent said first longitudinal edge, said at least one groove being intermediate said top end and said bottom end;
a top panel member, said top panel member configured to be removably coupled to said at least two side panel members, said top panel member having opposing side edges, said top panel member having an upper edge and a lower edge, said top panel member having a groove, said groove being formed intermediate said opposing side edges;
a bottom panel member, said bottom panel member configured to be removably coupled to said at least two side panel members, said bottom panel member having opposing side edges, said bottom panel member having an upper edge and a lower edge, said bottom panel member having a groove, said groove being formed intermediate said opposing side edges; and
a back panel member, said back panel member configured to be removably coupled to said at least two side panel members, said top panel member and said bottom panel member, said back panel member having opposing longitudinal edges, said back panel member having an upper edge and a lower edge, said back panel member having a rabbet groove along said opposing longitudinal edges and said upper edge and lower edge,
wherein the cabinet can be disassembled after assembly and reassembled after disassembly without replacement of the fasteners and panels.

2. The cabinet as recited in claim 1, wherein said plurality of panels further include a multitude of locking mechanisms, said multitude of locking mechanisms configured to operably couple said plurality of panels.

3. The cabinet as recited in claim 2, wherein said plurality of panels have formed thereon a multitude of locking receptacles, said locking receptacles configured to operably couple with said multitude of locking mechanisms so as to secure said plurality of panels to each other.

4. The cabinet as recited in claim 3, wherein the grooves on the at least two side panels are formed from one of the following types of grooves: a stopped groove or a through groove.

5. The cabinet as recited in claim 4, and further including at least one fastener, said at least one fastener operably coupled intermediate said back panel member and said top panel member.

6. The cabinet as recited in claim 5, wherein said back panel member is coupled to said body utilizing said rabbet groove present on the opposing longitudinal edges of said back panel member and said upper edge and lower edge of said back panel member.

7. A cabinet configured to be shipped in a disassembled state and subsequently assembled so to have load bearing capability wherein the cabinet comprises:
a plurality of fasteners, said fasteners formed from a combination of lock dowels and slidable locking receptacles
two side panel members, said two side panel members being rectangular in shape having a first longitudinal edge and a second longitudinal edge, said two side panel members having a top end and a bottom end, said two side panel members having a groove, said groove being formed on an inner surface of each of said two side panels, said groove being formed adjacent said first longitudinal edge, said groove being intermediate said top end and said bottom end;
a top panel member, said top panel member configured to be removably coupled to said two side panel members, said top panel member having opposing side edges, said top panel member having an upper edge and a lower edge, said top panel member having a groove, said groove being formed intermediate said opposing side edges;
a bottom panel member, said bottom panel member configured to be removably coupled to said two side panel members, said bottom panel member having opposing side edges, said bottom panel member having an upper edge and a lower edge, said bottom panel member having a groove, said groove being formed intermediate said opposing side edges; and
a back panel member, said back panel member configured to be removably coupled to said two side panel members, said top panel member and said bottom panel member, said back panel member having opposing longitudinal edges, said back panel member having an upper edge and a lower edge, said back panel member having a rabbet groove along said opposing longitudinal edges and said upper edge and lower edge, said back panel member further having at least one said fastener journaled therethrough into said top panel member,
wherein the cabinet can be disassembled after assembly and reassembled after disassembly without replacement of the fasteners and panels.

8. The cabinet as recited in claim 7, wherein the grooves on the two side panels are formed from one of the following types of grooves: a stopped groove or a through groove.

9. The cabinet as recited in claim 8, wherein said two side panel members, said top panel member and said bottom panel member further include a plurality of locking mechanisms, said multitude of locking mechanisms configured as barbed channel lock keys.

10. The cabinet as recited in claim 9, wherein said two side panel members, said top panel member and said bottom panel member further include a plurality of locking receptacles, said locking receptacles configured as a barbed channel key slot.
